(19) United States
(12) Patent Application Publication
(10) Pub. No.: US 2011/0000983 A1
(43) Pub. Date: Jan. 6, 2011

(54) Shower Head

(76) Inventor: Chung-Hsiang Chang, Taichung (TW)

Correspondence Address: Dr. BANGER SHIA;Patent Office of Bang Shia, 102 Lindencrest Ct, Sugar Land, TX, 77479-5201, US

(21) Appl. No.: 12/496,238

(22) Filed: Jul. 1, 2009

(51) Int. Cl. B05B 1/18

(52) U.S. Cl. 239/567

(57) ABSTRACT

A shower head comprises an upper body including a tubular portion having a passage formed therein, a connection including an arcuately-curved wall extending radially and having multiple spaced impellers extending downward, each impeller including an arc-shaped biasing end mounted on an inner side thereof and extending downward to define a fixing space, a disc portion including an upper surface fixed on a bottom end thereof; a lower body including a concave lower wall having a conical guiding member extending upward and having an arcuate peripheral side extending downward, wherein the peripheral side is received in the fixing space to abut against the biasing ends so that the peripheral side defines an arc-shaped offset passage extending downward between the arcuately-curved wall and any two abutting impellers; the lower wall engaging with the upper body to define multiple radially extending channels and including multiple outlets to spray water arranged along the channels.

### BACKGROUND OF THE INVENTION

1. Field of the Invention

The present invention relates to a shower head which supplies water with small flowing amount and high efficiency.

2. Description of the Prior Art

Conventional shower head includes an upper disc with an inlet and a lower disc connected to a lower side of the upper disc and having a plurality of outlets, a hollow flowing space between the upper and the lower discs, such that after water flows into the flowing space from the inlet of the upper disc, the water will spray outward from the outlets. However, such a conventional shower head has the following disadvantages:

The water is not limited in the hollow flowing space but flowing freely to lose its flowing energy and pressure, thereby lowering spraying efficiency. Besides, the watering amounts of the outlets are not equal as the watering amount is less than 2.5 GPM, and the shower head does not face downward but being limited at a predetermined angle to reduce flowing energy more greatly.

In addition, a conventional shower head with a larger size includes a hollow flowing space, therefore its lower disc bears more pressure to deform the shower head to generate a water leak.

CN Pat. No. ZL200580000294.7 discloses that an improved shower head includes an upper and a lower discs, and a watering member between the upper and the lower discs to separate a watering passage and a non-watering passage apart so as to guide waterflow flow toward a plurality of outlets, thus lowering flowing pressure. Nevertheless, the shower head includes a plurality of channels with multiple outlets, accordingly when water flows into the channels from inlets of the upper disc and is guided to the channels, the curved guiding way will result in a lower flowing energy to reduce watering amount. Furthermore, the watering passage includes a number of sector areas, but the watering amount of the sector areas are smaller than that of the watering passage, and after the water which flows from the inlet of the upper disc flows into the watering passage, the flowing direction will converted into a horizontal direction from a vertical direction to lower flowing energy and pressure, thereby reducing spraying efficiency, especially as the flowing amount is less than 2.5 GPM.

The present invention has arisen to mitigate and/or obviate the afore-described disadvantages.

### SUMMARY OF THE INVENTION

The primary object of the present invention is to provide a shower head which is capable of overcoming the shortcomings of the conventional shower head.

Another object of the present invention is to provide a shower head which supplies water with small flowing amount and high efficiency.

A shower head in accordance with a preferred embodiment of the present invention comprises:

an upper body including a tubular portion, a disc portion, a connection between the tubular portion and the disc portion, wherein the tubular portion includes a passage formed therein, the connection includes an arcuately-curved wall extending radially from a lower side of the passage and having a plurality of impellers extending downward and radially from the arcuately-curved wall and spaced apart from each other, and each impeller includes an arc-shaped biasing end mounted on an inner side thereof and extending downward to define a fixing space, the disc portion includes an upper surface fixed on a bottom end thereof;

a lower body connected to a lower side of the upper body and including a concave lower wall having a conical guiding member extending upward from a central portion of the lower wall and having an arcuate peripheral side extending downward, wherein at least one segment of the peripheral side is received in the fixing space of the upper body to abut against the biasing ends of the impellers so that the peripheral side defines an arc-shaped offset passage which extends downward between the arcuately-curved wall and any two abutting impellers; the lower wall engages with the upper body to define a plurality of radially extending channels to communicate with the arc-shaped offset passage; the lower wall includes a number of outlets to spray water arranged along the channels;

wherein between the upper surface of the upper body and the lower wall of the lower body are defined a number of triangle first abutting portions so that between any two first abutting portions is defined the channel;

wherein a watering path on an internal side of the first abutting portion leaves the lower wall a certain distance away from bottom walls of the impellers so as to form a first passageway, such that waterflow before being guided to the channels is adjusted its flowing amount equally;

wherein between the upper surface of the upper body and the lower wall of the lower body is defined an annular second abutting portion such that a second passageway is defined between the second abutting portion and the first abutting portions, so that the waterflow flows through the channels and into the second passageway to adjust and generate equal flowing effect;

wherein the upper surface of the upper body includes an upper contact rim formed around an outer side thereof, and the lower wall of the lower body includes an abutting protrusion formed thereon to engage with the upper contact rim of the upper surface;

wherein the width and height of the channel becomes reduced outward so that a cross-sectional area of waterflow become small outward to enhance flowing speed;

wherein a cross-sectional area of waterflow of an inlet of each channel is 1.5 times larger than that of an export thereof;

wherein the upper and the lower bodies are screwed together on at least one selected first abutting portion by using a first bolt;

wherein a top end of the guiding member extends out of the impellers to insert to the tubular portion of the upper body and to define five offset passages;

wherein the lower body includes a plurality of positioning bores disposed thereon to receive a number of nozzles which are also fitted to the outlets;

wherein the shower head further comprises an annular lid located under the lower body and including a plurality of second through holes to receive the nozzles;

wherein the shower head further comprises a lower cover including an opening attached on a top wall thereof and having a first peripheral tab to retain the lower cover between the lower body and the annular lid;

wherein the shower head further comprises a coupling member including first outer threads disposed on a bottom end thereof to screw with the first inner threads of the tubular portion of the upper body, and a third passageway arranged therein to communicate with the passage of the tubular portion;

wherein the third passageway of the coupling member includes a downward reduced first section proximate to a top end thereof;

wherein the first section also includes a sleeve retained therein;

wherein the shower head further comprises an upper cover including an intake disposed on a top wall thereof and having a second peripheral tab to retain the upper cover between the coupling member and the upper body, and a bottom wall of the upper cover extends to a periphery of the upper body;

wherein the shower head further comprises a spheral knob attached on a bottom end of the coupling member and having a fourth passageway to communicate with a top end of the coupling member so that the coupling member rotates around the spheral knob to adjust water spraying angle;

wherein the shower head further comprises a casing including second inner threads to screw with a top end of the upper cover, an upper washer located in the top end of the casing and including a first arcuately concave surface, a lower washer located in the top end of the upper cover and including a second arcuately concave surface.

### BRIEF DESCRIPTION OF THE DRAWINGS

FIG. 1 is a perspective view showing the assembly of a shower head in accordance with a preferred embodiment of the present invention;

FIG. 2 is a perspective view showing the exploded components of the shower head in accordance with the preferred embodiment of the present invention;

FIG. 3 is another perspective view showing the exploded components of the shower head in accordance with the preferred embodiment of the present invention;

FIG. 4 is a cross sectional view showing the assembly of the shower head in accordance with the preferred embodiment of the present invention;

FIG. 5 is a cross sectional view showing the assembly of an upper and a lower bodies of the shower head in accordance with the preferred embodiment of the present invention;

FIG. 6 is a cross sectional view of an upper body of the shower head in accordance with the preferred embodiment of the present invention;

FIG. 7 is a perspective view of the upper body of the shower head in accordance with the preferred embodiment of the present invention;

FIG. 8 is a top plan view of the upper body of the shower head in accordance with the preferred embodiment of the present invention;

FIG. 9 is a bottom plan view of the upper body of the shower head in accordance with the preferred embodiment of the present invention;

FIG. 10 is a cross sectional of the lower body of the shower head in accordance with the preferred embodiment of the present invention;

FIG. 11 is a top plan view of the lower body of the shower head in accordance with the preferred embodiment of the present invention;

FIG. 12 is a perspective view of the lower body of the shower head in accordance with the preferred embodiment of the present invention;

FIG. 13 is a top plan view of the upper body and a guiding member of the lower body in accordance with the preferred embodiment of the present invention;

FIG. 14 is a cross sectional view showing the operation of the shower head in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

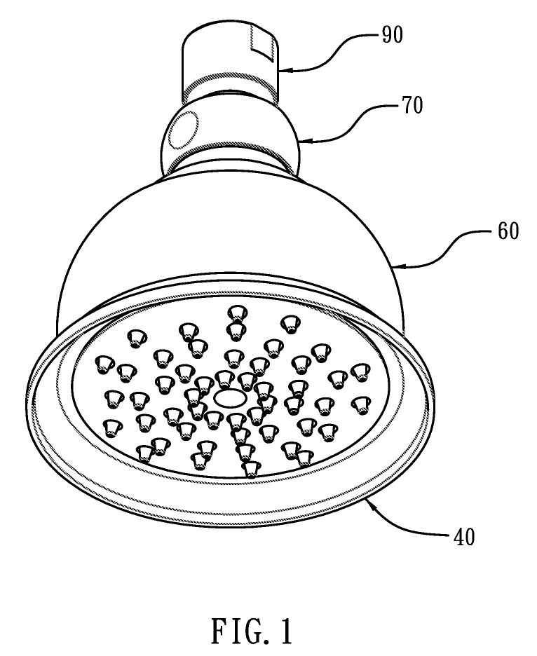

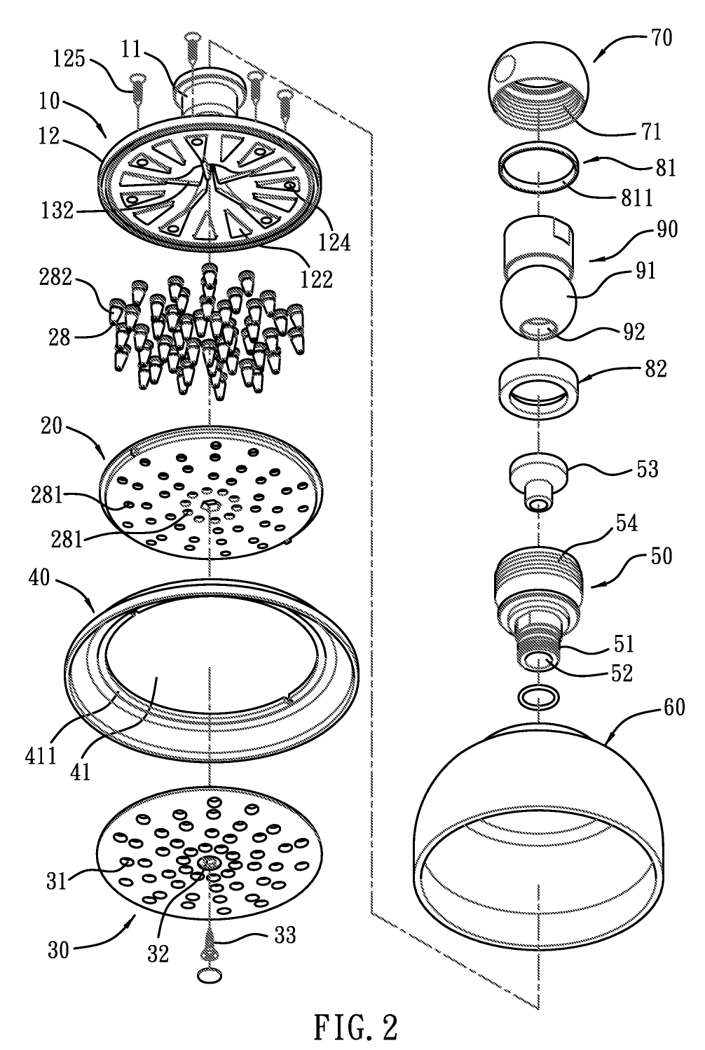

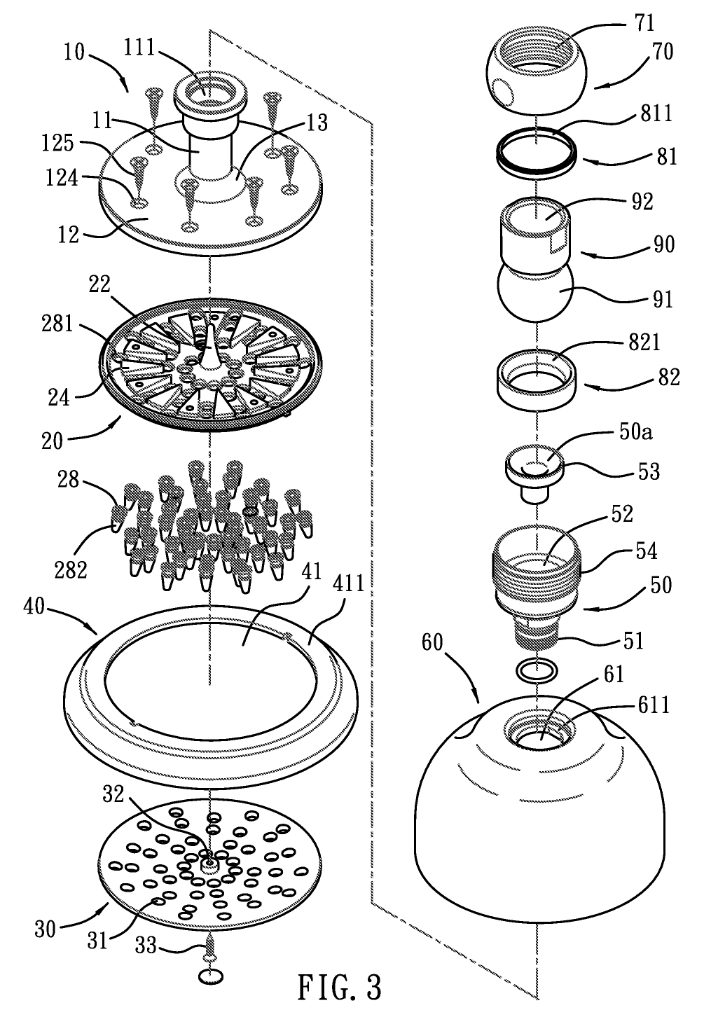

Referring to FIGS. 1-4, a shower head according to a preferred embodiment of the present invention comprises an upper body 10, a lower body 20, an annular lid 30, a lower cover 40, a coupling member 50, an upper cover 60, a casing 70, an upper washer 81, a lower washer 82, and a spherical connector 90.

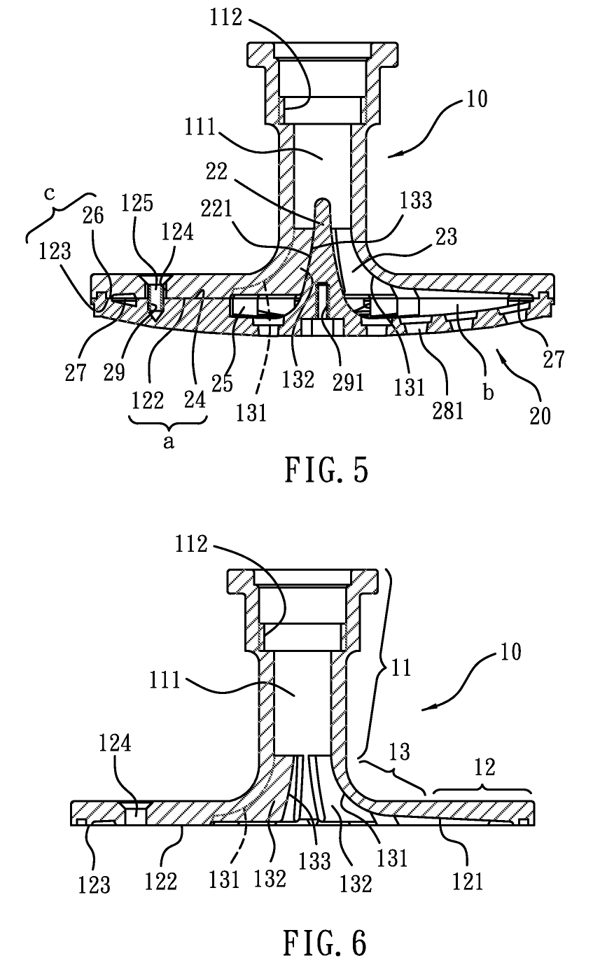

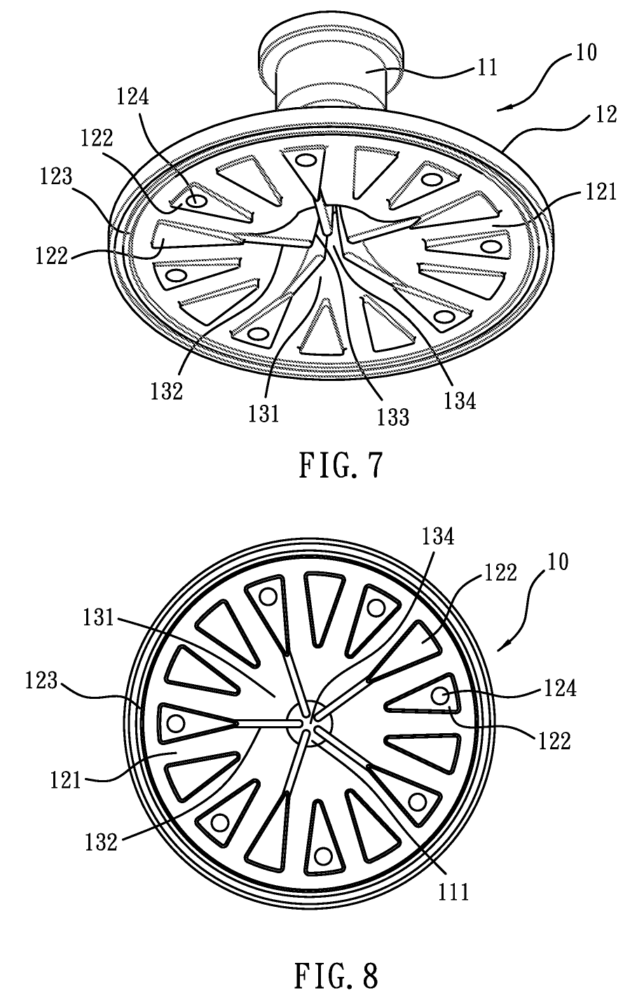

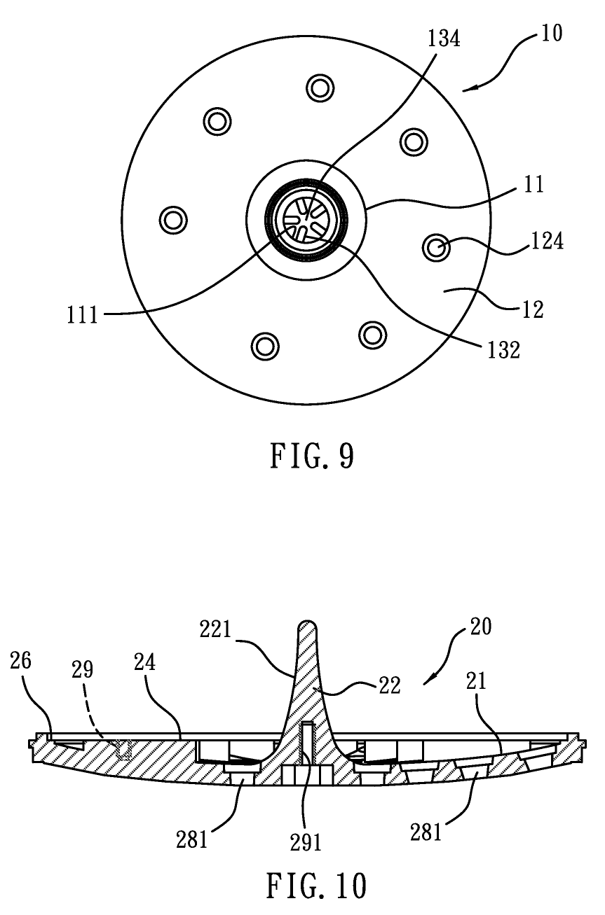

The upper body 10, as shown in FIGS. 5-9, includes a tubular portion 11, a disc portion 12, a connection 13 between the tubular portion 11 and the disc portion 12, wherein the tubular portion 11 includes a passage 111 formed therein and having first inner threads 112 arranged on a top end of the passage 111, the connection 13 includes an arcuately-curved wall 131 extending radially from a lower side of the passage 111 and having a plurality of impellers 132 extending downward and radially from the arcuately-curved wall 131 and spaced apart from each other. In this embodiment of the present invention, there are five impellers 132 extending downward and radially from the arcuately-curved wall 131 and spaced apart from each other, and each impeller 132 includes an arc-shaped biasing end 133 mounted on an inner side thereof and extending downward to define a fixing space 134 between the five impellers 132. The disc portion 12 includes an upper surface 121 fixed on a bottom end thereof and having a number of triangle contacting blocks 122 arranged around the upper surface 121, a tip end of the contacting block 122 faces inward and is proximate to the arcuately-curved wall 131. In this embodiment of the present invention, there are fifteen triangle contacting blocks 122 arranged around the upper surface 121 and spaced apart from each other equally, wherein the tip ends of the five contacting blocks 122 connect with the five impellers 132, and the heights of the contacting blocks 122 are larger than bottom walls of the impellers 132. The upper surface 121 includes an upper contact rim 123 formed around an outer side thereof. The disc portion 12 includes seven first through holes 124 located on seven of the contacting blocks 122, each first through hole 124 is used to screw a first bolt 125 therein.

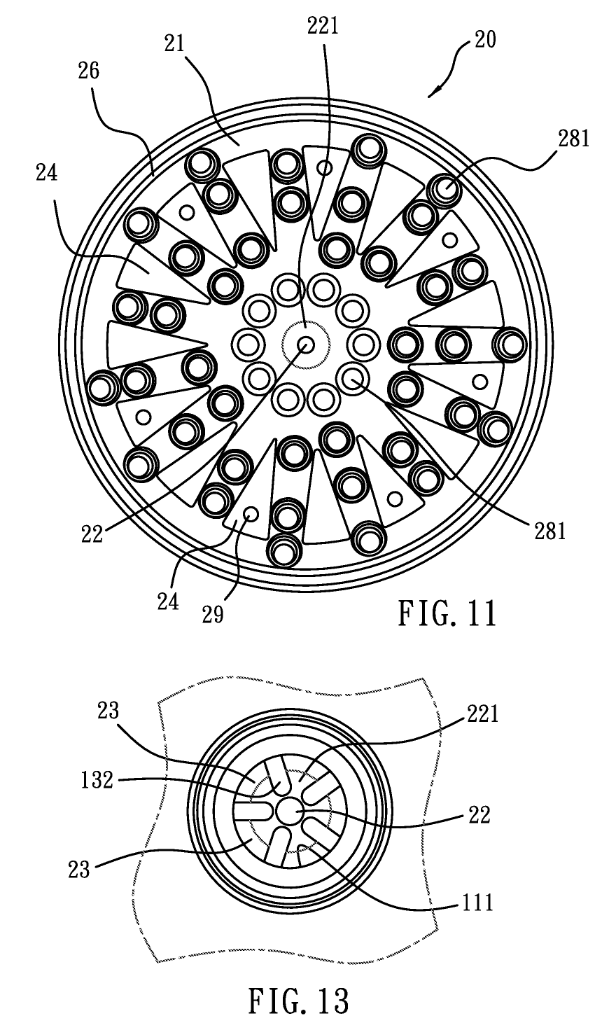

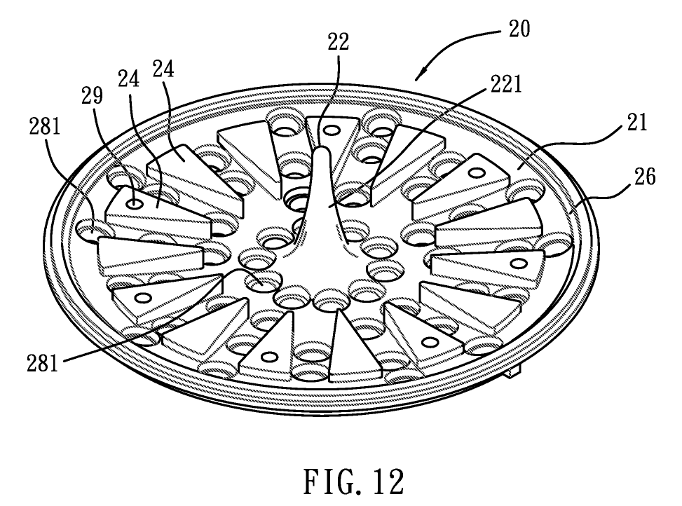

The lower body 20, as illustrated in FIGS. 10-13, is formed in a disc shape and connect to a lower side of the upper body 10, and includes a concave lower wall 21 fixed on a top surface thereof. The lower wall 21 includes a conical guiding member 22 extending upward from a central portion thereof and having an arcuate peripheral side 221 extending downward, at least one segment of the peripheral side 221 is received in the fixing space 134 to abut against the biasing ends 133 of the impellers 132 so that the peripheral side 221 defines an arc-shaped offset passage 23 which extends downward between the arcuately-curved wall 131 and any two abutting impellers 132; a top end of the guiding member 22 extends out of the impellers 132 to insert to the tubular portion 11 of the upper body 10 and to define five offset passages 23. The lower wall 21 includes a plurality of triangle engaging projections 24 arranged around the guiding member 22 to contact with the contacting blocks 122 so that a number of triangle first abutting portions a are formed between the upper surface 121 and the lower wall 21, hence between any two first abutting portions a is defined a radially extending channel b; In this embodiment of the present invention, there are fifteen channels b defined between the first abutting portions a, and the width and height of the channel b becomes reduced outward so that a cross-sectional area of waterflow become small outward to enhance flowing speed, wherein a cross-sectional area of waterflow of an inlet of each channel b is 1.5 times larger than that of an export thereof. Besides, a watering path on an internal side of the first abutting portion a leaves the lower wall 21 a certain distance away from bottom walls of the impellers 132 so as to form a first passageway 25 to communicate with the offset passages 23 and the channels b. Between the two impellers 132 is defined a sector area having one of the offset passages 23 and three of the channels b so that the waterflow flowing through the offset passage 23 is guided to the three channels b of the sector area, and the waterflow before being guided to the channels b is adjusted its flowing amount equally. The lower wall 21 includes an abutting protrusion 26 formed thereon to space the engaging projection 24 apart from a certain distance so as to engage with the upper contact rim 123 of the upper surface 121, hence between the upper surface 121 and the lower wall 21 is defined an annular second abutting portion c such that a second passageway 27 is defined between the second abutting portion c and the first abutting portions a, so that the waterflow flows through the channels b and into the second passageway 27 to adjust and generate equal flowing effect. The lower wall 21 includes a number of outlets 28 to spray water arranged in the first passageway 25, the channels b and the second passageway 27 individually. In the embodiment of the present invention, the lower body 20 includes a plurality of positioning bores 281 disposed thereon to receive a number of nozzles 282 which are also fitted to the outlets 28, wherein the first passageway 25 includes ten outlets 28 mounted therein, five of the outlets 28 are located under the impeller 132 to pass across two abutting sector areas, and between each channel b and a connecting portion of the first passageway 25 and the second passageway 27 are provided another two or three outlets 28. Also, each sector area includes eight outlets 28 to form a spraying module, wherein a distance from a center of each outlet 28 of the same module to a central point of the lower wall 21 is not equal so as to generate an equal spraying effect. Seven engaging projections 24 are arranged on the lower body 20 and each includes a first screw aperture 29 disposed therein to screw with the first bolt 125 so that the lower body 20 is coupled to the lower side of the upper body 10. The lower body 20 includes a second screw aperture 291 mounted on a bottom surface thereof relative to a bottom of the guiding member 22. A diameter of the outlet 28 is around 0.8 mm, and the nozzle 282 includes a flowing way with a predetermined length secured close to its opening to spray the water strongly.

The annular lid 30 is located under the lower body 20 and includes a plurality of second through holes 31 to receive the nozzles 282, and includes an orifice 32 fixed on a central portion thereof to screw with the second screw aperture 291 of the lower body 20 by means of a second bolt 33, hence the annular lid 30 is secured to the lower body 20.

The lower cover 40 includes an opening 41 attached on a top wall thereof and having a first peripheral tab 411 to retain the lower cover 40 between the lower body 20 and the annular lid 30 and to protect the outlets 28.

The coupling member 50 includes first outer threads 51 disposed on a bottom end thereof to screw with the first inner threads 112 of the tubular portion 11 of the upper body 10, a third passageway 52 arranged therein to communicate with the passage 111 of the tubular portion 11, wherein the third passageway 52 includes a downward reduced first section 50a proximate to a top end thereof to concentrate waterflow and enhance water pressure. The first section 50a also includes a sleeve 53 retained therein or is integrally formed from the third passageway 52 of the coupling member 50. In addition, the coupling member 50 further includes second outer threads 54 arranged on a top end thereof.

The upper cover 60 includes an intake 61 disposed on a top wall thereof and having a second peripheral tab 611 to retain the upper cover 60 between the coupling member 50 and the upper body 20, a bottom wall of the upper cover 60 contacts with a top surface of the lower cover 40 to be held by a user and to obtain protective effect.

The casing 70 includes second inner threads 71 to screw with a top end of the upper cover 60.

The upper washer 81 is located in the top end of the casing 70 and includes a first arcuately concave surface 811.

The lower washer 82 is located in the top end of the upper cover 60 and includes a second arcuately concave surface 821.

The connector 90 includes a spheral knob 91 attached on a bottom end thereof to be limited between the first arcuately concave surface 811 of the upper washer 81 and the second arcuately concave surface 821 of the lower washer 82 so that the coupling member 50 rotates around the connector 90, and the connector 90 also includes a fourth passageway 92 mounted therein to communicate with the third passageway 52 of the coupling member 50, a top end of the connector 90 is used to couple with a water feeding pipe (not shown) to supply water.

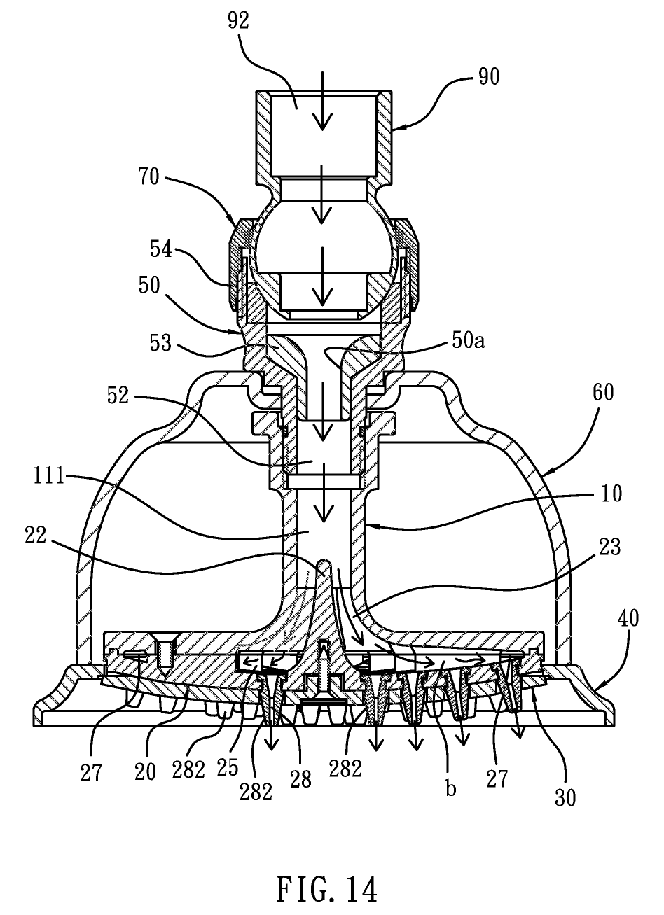

As shown in FIGS. 1, 4, and 14, the shower head of the present invention is used to coupled to the water feeding pipe of a shower room, therefore when a watering switch is turned on, the waterflow flows into the fourth passageway 92 of the connector 90 along the water feeding pipe and then flows through the third passageway 52 of the coupling member 50. During this water flowing period, the waterflow is adjusted by the downward reduced section 50a of the coupling member 50 so that the adjusted waterflow is guided to flow into a central portion of the passage 111 of the upper body 10 equally. Thereafter, the water in the passage 111 flows toward a periphery of the passage 111 and then flows to the offset passages 23 evenly, hence the flowing direction of water is converted into a horizontal direction form the vertical direction by using the offset passages 23 to reduce the energy loss of water, and the water flows through the first passageway 25 radially and further flows into the three channels b in the sector area so as to reach the second passageway 27, thus filling water with the first passageway 25, the channels b, and the second passageway 27 to spray water from the outlets 28 of the nozzles 282 of the second passageway 27 equally and efficiently.

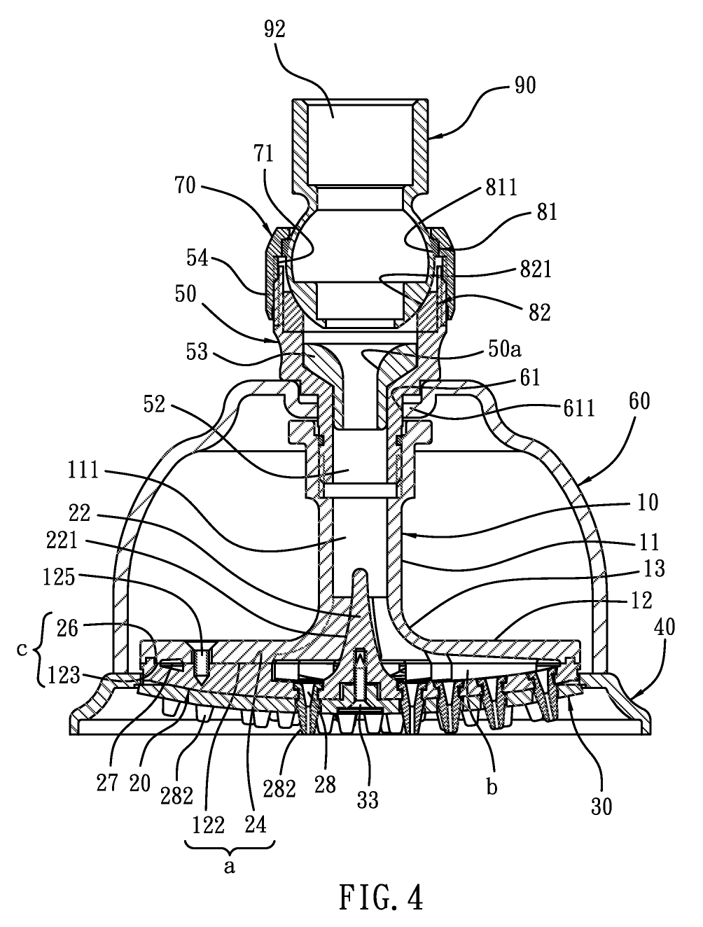

With reference to FIGS. 1 and 4, the coupling member 50 allows to be adjusted to any desired angle so as to control the watering angles of the outlets 28, wherein when the nozzles 28 are set at a certain angle, the waterflow will be affected by gravity, especially the adjusted angles become inclined greatly. By using the first passageway 25, the waterflow in the first passageway 25 adjusts its amount before flowing into the channels b so as to ensure the nozzles 282 to spray water evenly. By ways of the second passageway 27, the waterflow passing through the channels b allows to adjust its flowing amount in the second passageway 27 so as to ensure the nozzles 282 of the second passageway 27 and the channels b to spray water equally.

While we have shown and described various embodiments in accordance with the present invention, it is clear to those skilled in the art that further embodiments may be made without departing from the scope of the present invention.

What is claimed is:

1. A shower head comprising:
an upper body including a tubular portion, a disc portion, a connection between the tubular portion and the disc portion, wherein the tubular portion includes a passage formed therein, the connection includes an arcuately-curved wall extending radially from a lower side of the passage and having a plurality of impellers extending downward and radially from the arcuately-curved wall and spaced apart from each other, and each impeller includes an arc-shaped biasing end mounted on an inner side thereof and extending downward to define a fixing space, the disc portion includes an upper surface fixed on a bottom end thereof;
a lower body connected to a lower side of the upper body and including a concave lower wall having a conical guiding member extending upward from a central portion of the lower wall and having an arcuate peripheral side extending downward, wherein at least one segment of the peripheral side is received in the fixing space of the upper body to abut against the biasing ends of the impellers so that the peripheral side defines an arc-shaped offset passage which extends downward between the arcuately-curved wall and any two abutting impellers; the lower wall engages with the upper body to define a plurality of radially extending channels to communicate with the arc-shaped offset passage; the lower wall includes a number of outlets to spray water arranged along the channels.

2. The shower head as claimed in claim 1, wherein between the upper surface of the upper body and the lower wall of the lower body are defined a number of triangle first abutting portions so that between any two first abutting portions is defined the channel.

3. The shower head as claimed in claim 2, wherein a watering path on an internal side of the first abutting portion leaves the lower wall a certain distance away from bottom walls of the impellers so as to form a first passageway, such that waterflow before being guided to the channels is adjusted its flowing amount equally.

4. The shower head as claimed in claim 2, wherein between the upper surface of the upper body and the lower wall of the lower body is defined an annular second abutting portion such that a second passageway is defined between the second abutting portion and the first abutting portions, so that the waterflow flows through the channels and into the second passageway to adjust and generate equal flowing effect.

5. The shower head as claimed in claim 2, wherein the upper surface of the upper body includes an upper contact rim formed around an outer side thereof, and the lower wall of the lower body includes an abutting protrusion formed thereon to engage with the upper contact rim of the upper surface.

6. The shower head as claimed in claim 4, wherein the width and height of the channel becomes reduced outward so that a cross-sectional area of waterflow become small outward to enhance flowing speed.

7. The shower head as claimed in claim 4, wherein a cross-sectional area of waterflow of an inlet of each channel is 1.5 times larger than that of an export thereof.

8. The shower head as claimed in claim 2, wherein the upper and the lower bodies are screwed together on at least one selected first abutting portion by using a first bolt.

9. The shower head as claimed in claim 1, wherein a top end of the guiding member extends out of the impellers to insert to the tubular portion of the upper body and to define five offset passages.

10. The shower head as claimed in claim 1, wherein the lower body includes a plurality of positioning bores disposed thereon to receive a number of nozzles which are also fitted to the outlets.

11. The shower head as claimed in claim 10 further comprising an annular lid located under the lower body and including a plurality of second through holes to receive the nozzles.

12. The shower head as claimed in claim 11 further comprising a lower cover including an opening attached on a top wall thereof and having a first peripheral tab to retain the lower cover between the lower body and the annular lid.

13. The shower head as claimed in claim 1 further comprising a coupling member including first outer threads disposed on a bottom end thereof to screw with the first inner threads of the tubular portion of the upper body, and a third passageway arranged therein to communicate with the passage of the tubular portion.

14. The shower head as claimed in claim 13, wherein the third passageway of the coupling member includes a downward reduced first section proximate to a top end thereof.

15. The shower head as claimed in claim 14, wherein the first section also includes a sleeve retained therein.

16. The shower head as claimed in claim 13 further comprising an upper cover including an intake disposed on a top wall thereof and having a second peripheral tab to retain the upper cover between the coupling member and the upper body, and a bottom wall of the upper cover extends to a periphery of the upper body.

17. The shower head as claimed in claim 13 further comprising a spheral knob attached on a bottom end of the coupling member and having a fourth passageway to communicate with a top end of the coupling member so that the coupling member rotates around the spheral knob to adjust water spraying angle.

18. The shower head as claimed in claim 17 further comprising a casing including second inner threads to screw with a top end of the upper cover, an upper washer located in the top end of the casing and including a first arcuately concave surface, a lower washer located in the top end of the upper cover and including a second arcuately concave surface.
